(19) United States
(12) Patent Application Publication
(10) Pub. No.: US 2017/0039338 A1
(43) Pub. Date: Feb. 9, 2017

(54) HEALTHCARE RESOURCE AVAILABILITY AND ALLOCATION SYSTEMS AND METHODS

(71) Applicants: Aditya KHINDARIA, Belmont, NC (US); Alexandra DIACONESCU, Bucharest (RO); Robert DEMARINO, Southport, NC (US)

(72) Inventors: Aditya KHINDARIA, Belmont, NC (US); Alexandra DIACONESCU, Bucharest (RO); Robert DEMARINO, Southport, NC (US)

(73) Assignee: KURE TECHNOLOGY SERVICES, LLC, Matthews, NC (US)

(21) Appl. No.: 14/821,071

(22) Filed: Aug. 7, 2015

(51) Int. Cl. G06F 19/00; G06Q 50/22; G06Q 30/02

(52) U.S. Cl. CPC G06F 19/3425; G06Q 30/0282; G06Q 50/22

(57) ABSTRACT

Healthcare resource availability and allocation systems and methods include, for each of a plurality of healthcare providers, receiving data including one or more of ratings, type, availability, and location, and managing the data in a data store; from a physician with an associated patient, receiving a query for healthcare resources fulfilled by a healthcare provider of the plurality of healthcare providers; providing a subset of healthcare providers responsive to the query based in part of factors including the type, the availability, and the location; and receiving an allocation request for the healthcare provider, which is one of the subset, from the physician or the associated patient, and providing the allocation request to the healthcare provider for the fulfillment of the healthcare resources.

### FIELD OF THE DISCLOSURE

The present disclosure generally relates to a computer-implemented systems and methods. More particularly, the present disclosure relates to healthcare resource availability and allocation systems and methods operating between mobile devices and a back-end server architecture.

### BACKGROUND OF THE DISCLOSURE

In healthcare, effective patient care requires the coordination of multiple resources from Designated Healthcare Services Providers (e.g. physicians, outpatient clinics, home health agencies, imaging centers etc.). This coordination requires the timely selection of the best available resource in order to administer effective patient care. To be most effective, this decision should be made collaboratively by the physician and the patient. In today's healthcare system, health services are not consolidated (i.e., not under a single umbrella or provider); they are distributed across organizations. As a result, information about the best available resources is not visible in real-time for the physician and the patient to make the optimal choice for the patient, and quickly or immediately secure those resources. The resource data needed to make the decision on which provider is right and available, and to secure that provider is not organized and not available in a decision support type of environment for the physician to be able to improve patient care.

### BRIEF SUMMARY OF THE DISCLOSURE

In an exemplary embodiment, a healthcare resource availability and allocation method includes, for each of a plurality of healthcare providers, receiving data comprising one or more of ratings, type, availability, and location, and managing the data in a data store; from a physician with an associated patient, receiving a query for healthcare resources fulfilled by a healthcare provider of the plurality of healthcare providers; providing a subset of healthcare providers responsive to the query based in part of factors comprising the type, the availability, the rating, and the location; and receiving an allocation request for the healthcare provider, which is one of the subset, from the physician or the associated patient, and providing the allocation request to the healthcare provider for the fulfillment of the healthcare resources.

In another exemplary embodiment, a healthcare resource availability and allocation system includes a network interface and a processor communicatively coupled to one another; and memory storing instructions that, when executed, cause the processor to, for each of a plurality of healthcare providers, receive data, via the network interface, comprising one or more of ratings, type, availability, and location, and managing the data in a data store; from a physician with an associated patient, receive, via the network interface, a query for healthcare resources fulfilled by a healthcare provider of the plurality of healthcare providers; provide, via the network interface, a subset of healthcare providers responsive to the query based in part of factors comprising the type, the availability, rating, and the location; and receive, via the network interface, an allocation request for the healthcare provider, which is one of the subset, from the physician or the associated patient, and provide the allocation request to the healthcare provider for the fulfillment of the healthcare resources.

In a further exemplary embodiment, a mobile device includes a network interface, a location determination device, and a processor communicatively coupled to one another; and memory storing instructions that, when executed, cause the processor to provide data comprising one or more of ratings, type, availability, and location to a healthcare resource availability and allocation system; present a Graphical User Interface (GUI) responsive to received data from the healthcare resource availability and allocation system; perform a query for healthcare resources fulfilled by a healthcare provider of the plurality of healthcare providers; provide a subset of healthcare providers responsive to the query based in part of factors comprising the type, the availability, rating, and the location; and send an allocation request for the healthcare provider, which is one of the subset, from the physician or the associated patient.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of a system configured to provide healthcare resource availability and allocation;

FIG. 2 is a flow diagram of interactions associated with the system of FIG. 1;

FIG. 3 is a block diagram of a server which may be used in the system of FIG. 1, in other systems, or standalone;

FIG. 4 is a block diagram of a mobile device which may be used in the system of FIG. 1 or the like;

FIG. 5 is a flow diagram of exemplary system functionality of the system of FIG. 1;

FIGS. 6A and 6B are a flow diagram of a detailed system flow of the system of FIG. 1;

FIG. 7 is a Graphical User Interface (GUI) screen of a convenient mechanism of availability management in the system of FIG. 1;

FIGS. 8-19 are GUI screens of operations of the system of FIG. 1, on a mobile device of FIG. 4; and

FIG. 20 is a flow chart of a healthcare resource availability and allocation method.

### DETAILED DESCRIPTION OF THE DISCLOSURE

Again, in various exemplary embodiments, the present disclosure relates to healthcare resource availability and allocation systems and methods operating between mobile devices as well as browser-based implementations and a back-end server architecture. The systems and methods can be implemented via an application operating in the cloud between mobile devices with two logical components, namely a resource availability tool and resource allocation tool, which are tightly coupled and communicate with one another to enable the real-time engagement of healthcare resources. An objective of the systems and methods is to optimize resource utilization in the healthcare industry by creating, using, and managing an inventory pool based on human capital (time), location, and skills and rating.

In an exemplary embodiment, the resource availability tool is implemented in a mobile application (e.g., Apple iOS, Android, etc.) operating on a mobile device (e.g., smart phone, tablet, etc.). In another exemplary embodiment, the resource availability tool is used by a service provider (e.g., a physical therapist, a nurse, etc.) to manage their availability to provide services to patients. In a further exemplary embodiment, the resource availability tool is accessed through a Web browser, such as on a laptop, desktop, etc. The resource allocation tool can be embedded in a website or application used by health administrators who are responsible for coordination with patients. Upon receiving a referral to provide specific health care services to a patient, the resource allocation tool helps the administrator to optimize the selection of the service provider based on various criterion, such as specific skills and specialties of the service provider, geographic location or proximity of the service provider relative to the patient, time availability of the service provider, rating of the service provider (e.g., based on prior patients), and the like.

The systems and methods contemplate any other areas of healthcare resources and can be used for real-time planning, allocation and optimization of both human and physical resources. Specific examples can include, without limitation, locating surgical or diagnostic centers with appropriate availability of resources (e.g., nurses, physicians, technicians, radiologists, etc.) and equipment (e.g., X-ray, MRI, etc.) and real-time allocation of these resources to provide corresponding healthcare services.

### §1.0 Healthcare Resource Availability and Allocation System

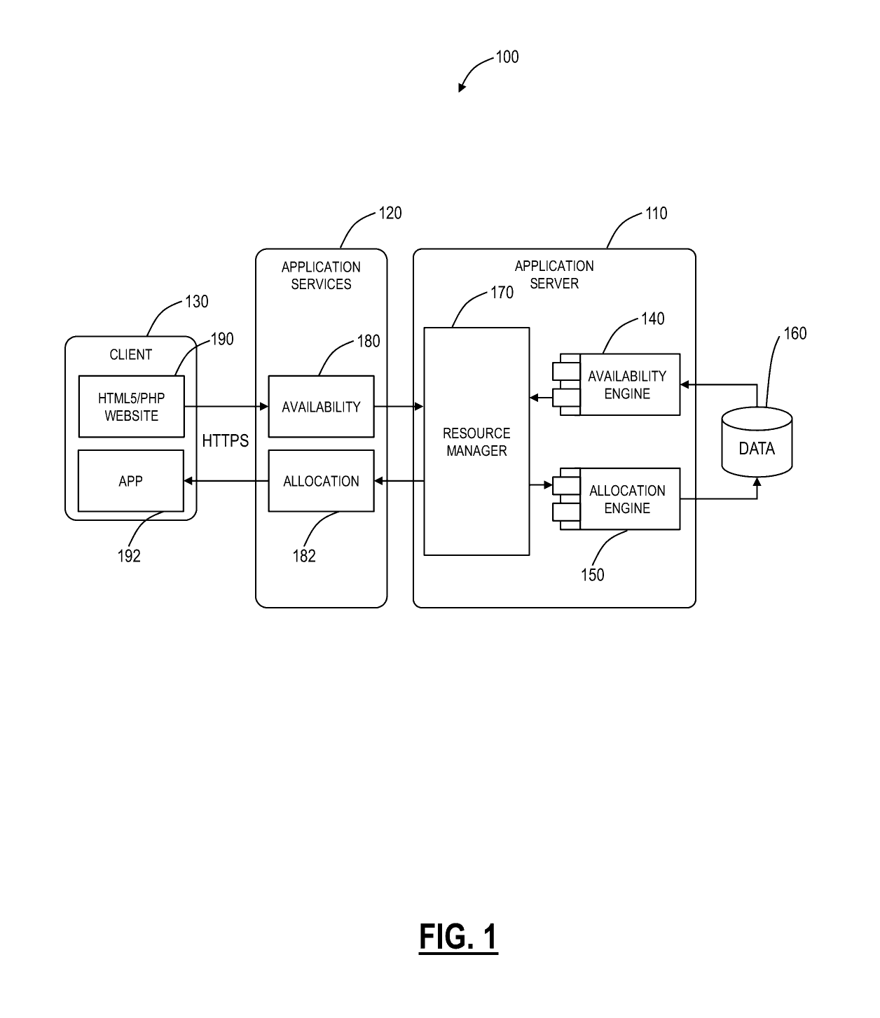

Referring to FIG. 1, in an exemplary embodiment, a block diagram illustrates a system 100 configured to provide healthcare resource availability and allocation. The system 100 is shown, for illustration purposes, with an application server 110, providing application services 120 to a client 130. Note, in a practical implementation, the system 100 can include a plurality of clients 130. The application server 110 can be one or more servers that include an availability engine 140 and an allocation engine 150, each coupled to a data store 160 and a resource manager 170. The resource manager 170 is configured to operate the application services 120, including a Resource Availability Service 180 and a Resource Allocation Service 182. The Services 180, 182 are façade for the details of the implementations inside the engines 140, 150. The client 130 can include a mobile device such as a smartphone, tablet, laptop, etc. and is configured to interact with the application services 120. For example, the client 120 can include a Web browser 190 configured to interact, over Hypertext Transfer Protocol Secure (HTTPS), with the Resource Availability Service 180 and an application (“app”) 192 configured to interact with the Resource Allocation Service 182.

The healthcare resource availability and allocation system 100 allows physicians and patients to identify quickly and select the right resources, from a pool of resource providers, needed for optimal patient care. Resource selection is based on a number of key elements critical to physicians and patients. Again, the system 100 includes the availability engine 140 supporting the Resource Availability Service 180 and the allocation engine supporting the Resource Allocation Service 182, each are tightly coupled and communicate with each other to enable the real-time engagement of healthcare resources to improve the coordination of patient care. Advantageously, the system 100 is a standalone system, i.e., does not require integration with existing back-office solutions in conventional healthcare systems to be effective.

To understand the relevance, significance and potential of the resource availability tool, implemented through the availability engine 140, one must first imbibe the Just in Time production strategy, so widely used to revolutionize manufacturing goods. Services, as opposed to manufacturing goods, inherently and traditionally have suffered from lack of optimization of the key elements needed to provide the best possible provider choice (resource type/services, location, quality and time) due to inability to create pools of inventory. It is an exemplary objective of the system 100 to create a Just in Time model for healthcare provider services. As described herein, healthcare providers can be Designated Healthcare Services Providers. This is maintained through online and mobile media, which are instantly updated and ideal for use by physicians and patients for the coordination of care. The Resource Availability Service 180 will for the first time allow these inventories to be created, documented, localized, and their use monitored.

The Resource Allocation Service 182 enables the effective use of the above-mentioned inventory in healthcare markets. It is a tool that implements a specific algorithm/methodology that takes future pools of inventory and enables optimized selection and securement. For example, the use case for selecting home care providers enables the assignment of home healthcare clinical resources (e.g. agency, physical therapists, nurses) to patients for care at their homes, based upon availability of these resources, their specific skills and specialty services (e.g. physical therapist with a specialty in hand therapy), their historical service performance rating, and the proximity of the resource to the patient's home.

The system 100 can be extended to any healthcare domain allowing for real-time planning, allocation and optimization of both human and other physical resources. Specific examples can include, without limitation, locating and selecting outpatient centers, locating and selecting laboratories or diagnostic centers with the appropriate availability of the resources of time, people (e.g. therapists, nurses, physicians, technicians, radiologists), and locating and selecting equipment (e.g. MRI, X-ray, etc.), services (e.g. arthograms, angiograms, etc.) and real-time allocation of these resources to perform lab tests, outpatient therapy, scanning and other procedures. The resource availability and allocation process is unique in part because (1) it is efficient to use a graphical visual implementation instead of more burdensome calendaring; and (2) enables the efficient coordination of patient flow to allocate care resources depending on the availability, services provided, proximity and quality rating of all resources necessary to provide timely and appropriate care.

### §2.0 Flow Diagram

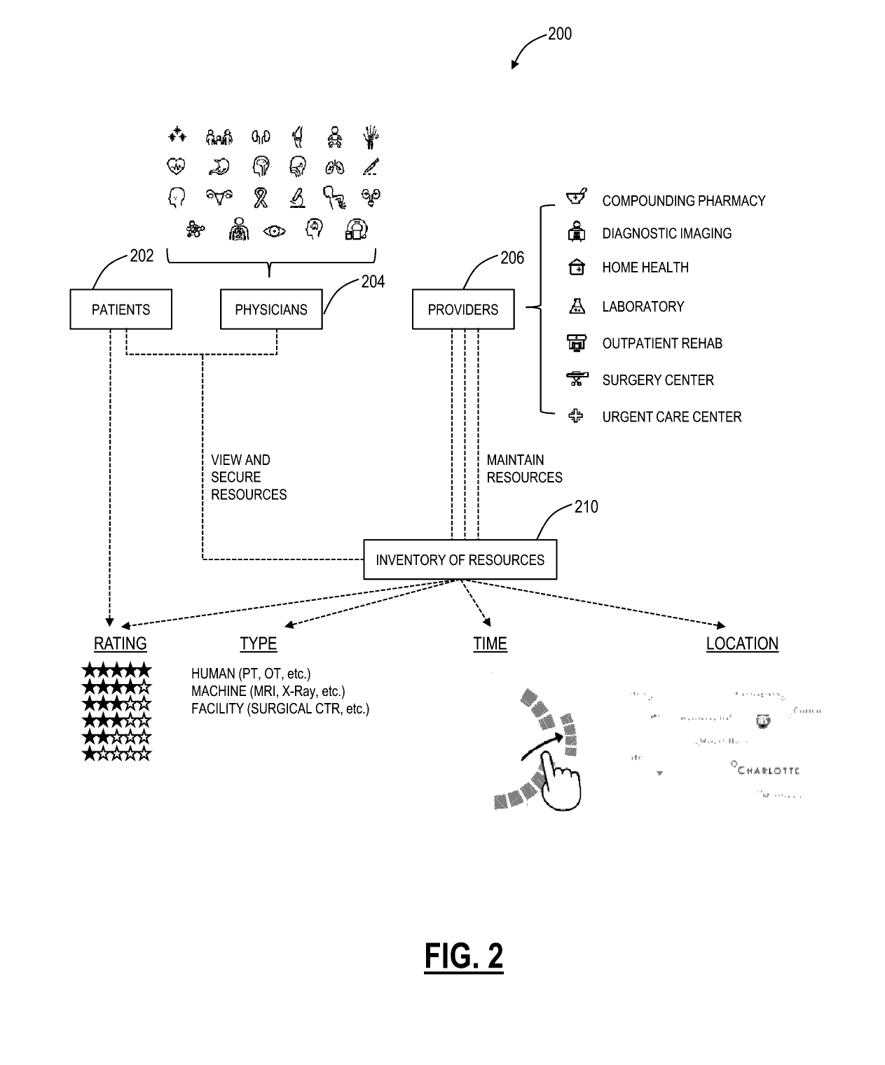

Referring to FIG. 2, in an exemplary embodiment, a flow diagram illustrates interactions 200 associated with the system 100. In particular, patients 202, physicians 204, and providers 206 can collectively utilize the system 100 to provide optimal service allocation between the patients 202 and the providers 206. The patients 202 are associated with the physicians 204 who are treating the patients 202 and recommending one or more of the providers 206 for the patients 202. The physicians 204 can be providing any type of healthcare, such as internal medicine, surgeons, cardiologists, dermatologists, obstetrician/gynecologist, orthopedic surgeon, pediatrician, etc. As part of providing the service, the physician 204 requires a provider 206 to provide some type of service for the patient 202. The provider 206 can include, without limitation, compounding pharmacy, diagnostic imaging, home healthcare services, laboratory services, outpatient rehabilitation services, surgery centers, urgent care centers, etc. The system 100 is configured to manage an inventory of resources 210, specifically, the resources 210 are maintained by the providers 206. That is, the resources 210 are availability over time of the providers 206. The patients 202 and/or the physicians 204 are allowed to view and secure the resources 210, through the system 100.

Further, the resources 210 can be categorized by rating, type, time, and location. The rating can be a representation of the opinion of the patients 202 who have previously used the provider 206. The type is a listing of what the provider 206 is—human resources (e.g., physical therapy (PT), occupational therapy (OT), etc.), machine resources (e.g., MRI, X-ray, etc.), facility resources (e.g., surgical center, etc.), and the like. The time and location are variables outlining the availability of the providers 206. With these four categories, the patients 202 and the physicians 204 can, in real-time, select the optimal provider 206 for a particular healthcare resource.

### §3.0 Exemplary Server Architecture

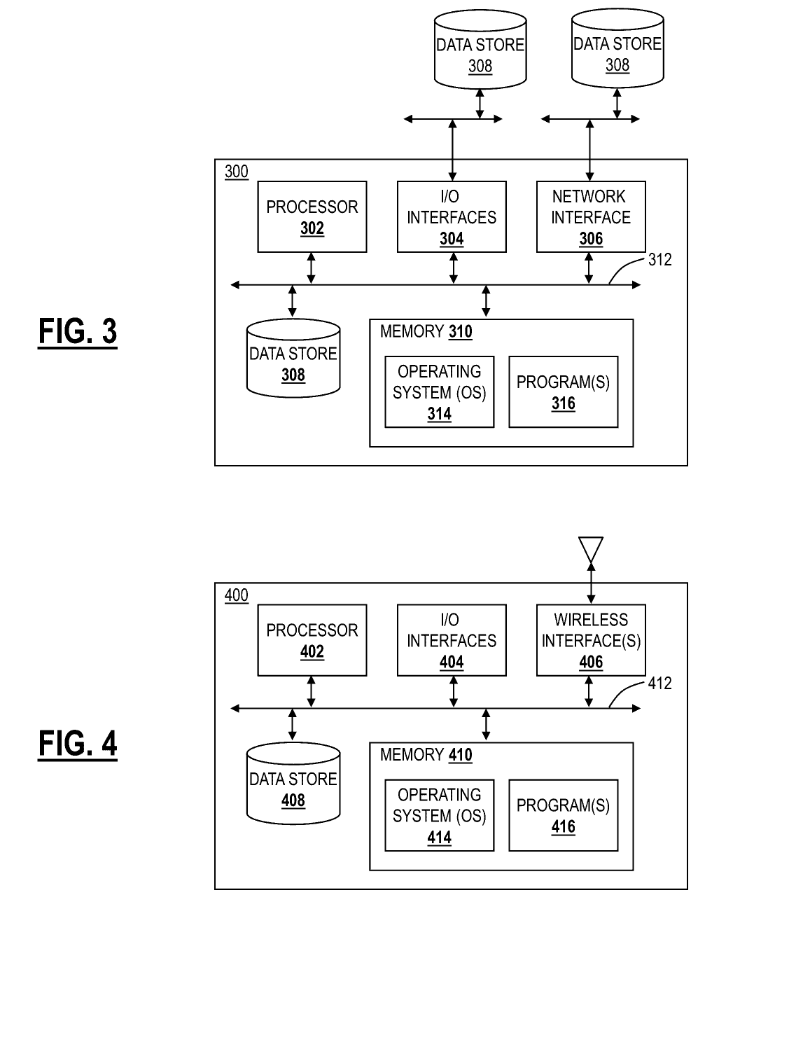

Referring to FIG. 3, in an exemplary embodiment, a block diagram illustrates a server 300 which may be used in the system 100, in other systems, or standalone. For example, the server 300 can be used to implement the application server 110, to operate the application services 120. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example, but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touchpad, and/or a mouse. The system output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate over a network, such as the Internet and the like. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 1208 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server. The data store 160 can be implemented as part of the data store 308.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

In an exemplary embodiment, the application server 110, the application services 120, and the data 160 can be operated and managed in the Cloud. Cloud computing systems and methods abstract away physical servers, storage, networking, etc. and instead offer these as on-demand and elastic resources. Cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser, with no installed client version of an application required. Centralization gives cloud service providers complete control over the versions of the browser-based applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.”

### §4.0 Exemplary Mobile Device Architecture

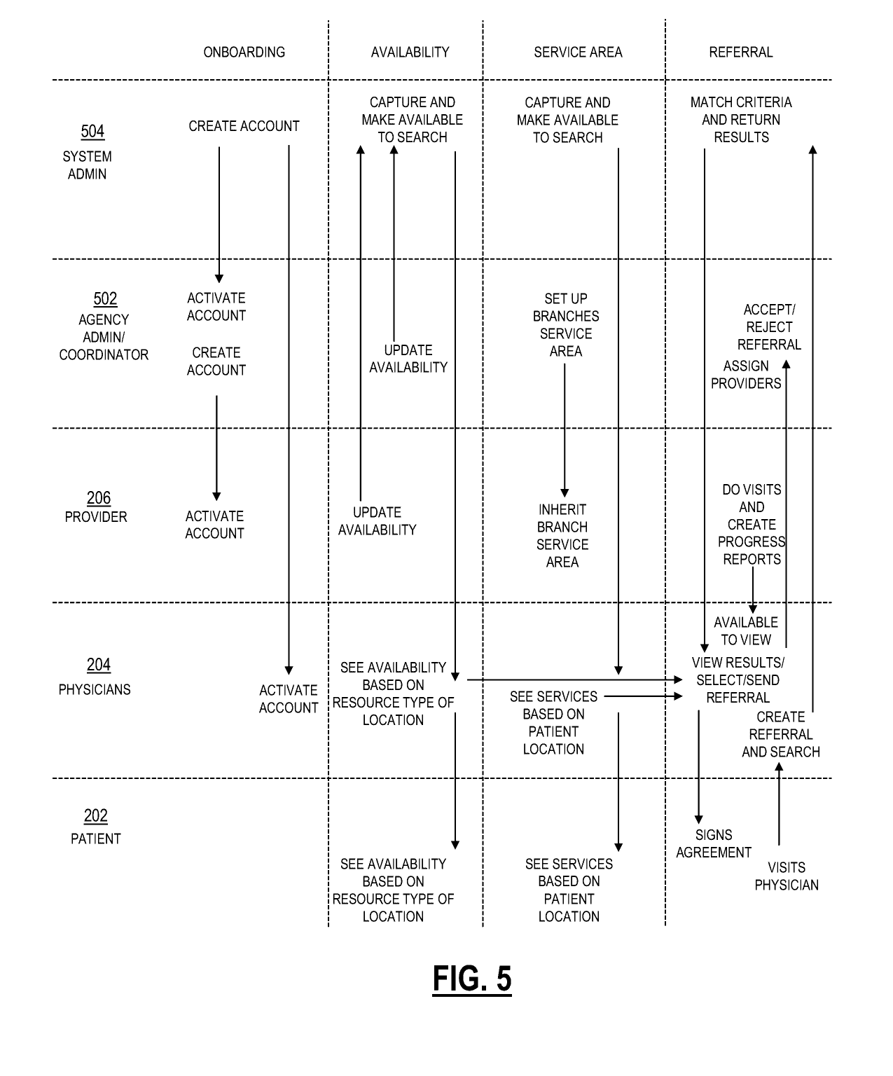

Referring to FIG. 4, in an exemplary embodiment, a block diagram illustrates a mobile device 400, which may be used in the system 100 or the like. The mobile device 400 can be used for the client 130, such as a smartphone, tablet, laptop, ultrabook, netbook, personal digital assistant, and the like. The mobile device 400 can be a digital device that, in terms of hardware architecture, generally includes a processor 402, input/output (I/O) interfaces 404, one or more wireless interfaces 406, a data store 408, and memory 410. It should be appreciated by those of ordinary skill in the art that FIG. 4 depicts the mobile device 400 in an oversimplified manner, and a practical embodiment may include additional components and suitably configured processing logic to support known or conventional operating features that are not described in detail herein. The components (402, 404, 406, 408, and 402) are communicatively coupled via a local interface 412. The local interface 412 can be, for example, but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 400, a semiconductor-based microprocessor (in the form of a microchip or chip set), or generally any device for executing software instructions. When the mobile device 400 is in operation, the processor 402 is configured to execute software stored within the memory 410, to communicate data to and from the memory 410, and to generally control operations of the mobile device 400 pursuant to the software instructions. In an exemplary embodiment, the processor 402 may include a mobile-optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 400. Additionally, the I/O interfaces 404 may further include an imaging device, i.e. camera, video camera, etc.

The wireless interfaces 406 enables wireless communication to an external access device or network. Any number of suitable wireless data communication protocols, techniques, or methodologies can be supported by the wireless interfaces 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 4, the software in the memory 410 includes a suitable operating system (O/S) 414 and programs 416. The operating system 414 essentially controls the execution of other computer programs and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like. In a typical example, the end user typically uses one or more of the programs 416 along with a network such as the system 100.

Also, the mobile device 400 can include a location determination device, such as a Global Positioning Satellite (GPS) module, which can be configured to provide the real-time location of the mobile device 400. In operation with the system 100, each of the patients 202, the physicians 204, and the providers 206 can have an associated mobile device 400. With the location determination device, proximity/geographical distance can be one factor that is used is resource availability and allocation. Another factor can be time, which can be managed by accessing a calendar on the mobile device 400 or the like.

### §5.0 System Functionality

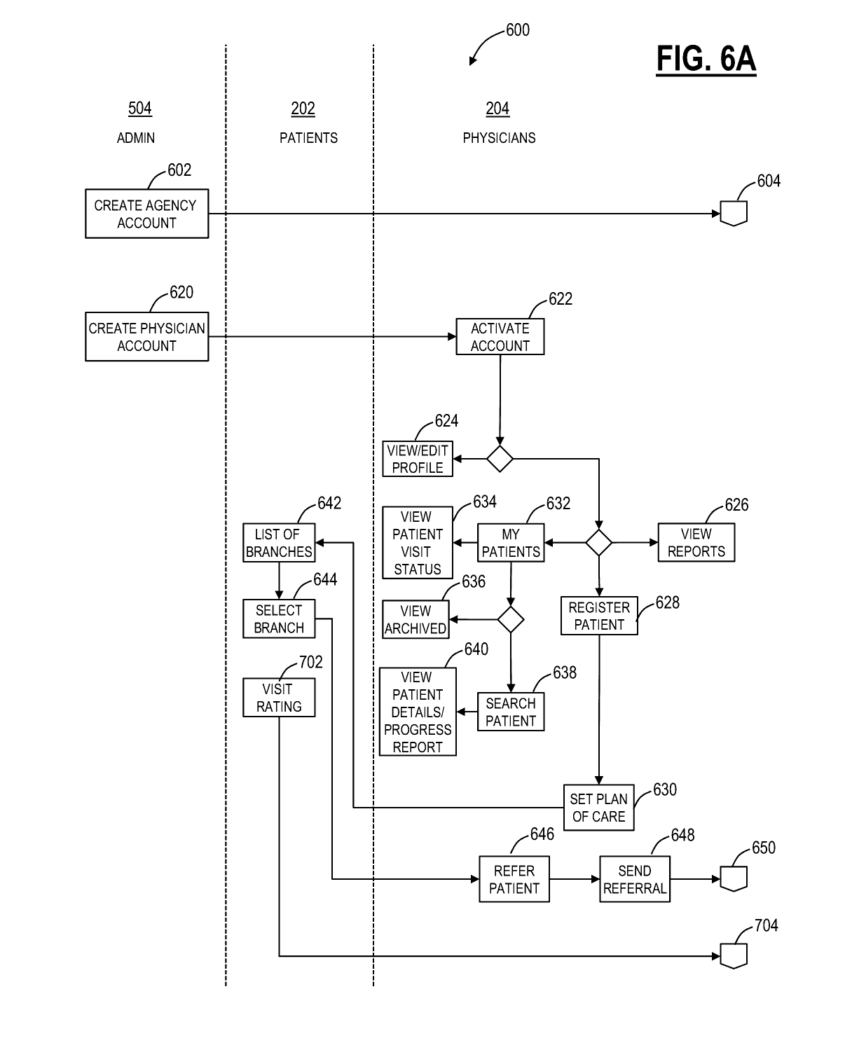

Referring to FIG. 5, in an exemplary embodiment, a flow diagram illustrates exemplary system functionality of the system 100. In addition to the patient 202, the physician 204, and the provider 206 previously described, there can be an agency admin/coordinator 502 and a system admin 504. For illustration purposes, four specific functions, onboarding, availability, service area, and referral, are described between the various users. Onboarding is the process of bringing users, the coordinator 502, the providers 206, and the physicians 204 into the system 100. For example, the system admin 504 can create an account for the coordinator 502 or the physician 204, and the coordinator 502 and the physician 204 can activate their account. The coordinator 502 can create an account with the provider 206 who can activate their account.

Availability is the process by which the users (the coordinator 502 and the providers 206) update the data 160 in the system 100 with their calendars. Again the coordinator 502 and the providers can have their mobile devices 400 provide their associated calendars to the system 100. The calendars can be from an external program or a built-in program on the mobile device 400. The calendars can also be from the system 100 through the availability tool. Also, the various different calendars can be configured to synchronize/share data with one another. This can be a real-time update whereby whenever a new appointment is scheduled, adjusted, etc., this data can be provided to the system 100 such that the data 160 is up-to-date with the current availability of the provider 206. As such, the physicians 204 and the patients 202 can see availability, in real-time, based on resource type and location.

Service area is used to correlate location. The coordinator 502 can set up branches' service area, and new providers 206 can inherit the service area (this can also be edited). This data is provided by the system 100, i.e., each provider 206 has a certain service area, and the physicians 204 and the patients 202 can see services based on a current location, as determined by the mobile device 400. Note, the search does not require a user to signify location; rather, the location can be automatically determined based on the mobile device 400. The branches, facilities, etc. have fixed locations. Mobile providers such as home health therapists do not, and can use GPS or the like to determine their location.

Finally, referral is the process where users determine their operation with the system 100. Again, the physicians 204 can use the system 100 to match criteria and return results for providers 206 to provide services to the patients 202. The coordinator 502 can accept/reject referrals and assign providers 206. After an appointment is set, the provider 206 can perform the service as well as keep track of progress through the system 100.

### §6.0 Detailed System Flow

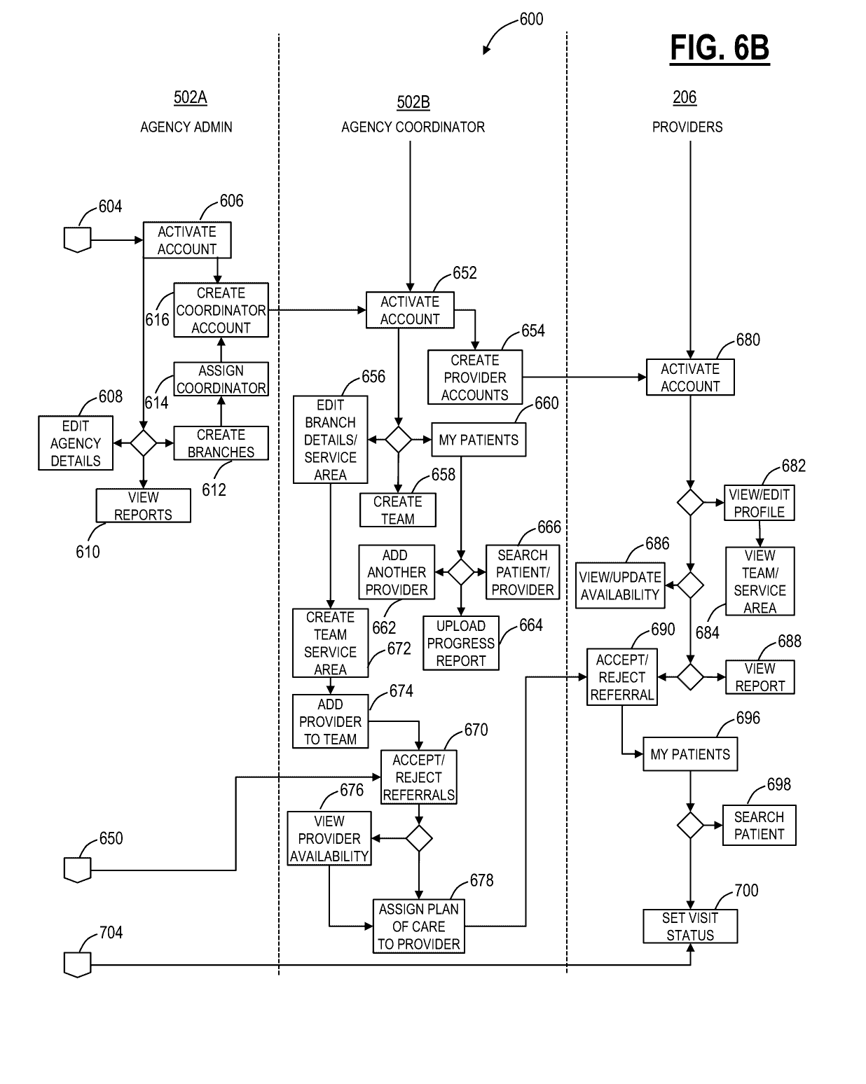

Referring to FIGS. 6A and 6B, in an exemplary embodiment, a flow diagram illustrates a detailed system flow 600 of the system 100. Again, the detailed system flow 600 includes the admin 504, the patients 202, the physicians 204, an agency admin 502A, an agency coordinator 502B, and the providers 206, and their associated interaction through the system 100. The admin 504 can create an agency account (step 602) for the agency admin 502 (step 604) which can activate the account (step 606). The agency admin 502 can edit agency details (step 608), view reports (step 610), create branches (612) and then assign coordinators (step 614), and/or create coordinator accounts (step 616).

The admin 504 can create a physician account (step 620) for the physician 204 which can activate the account (step 622). The physician 204 can view/edit profiles (step 624), view reports (step 626), register a patient (step 628) and set a plan of care (step 630), and select a patient (step 632). After a patient is selected, the physician 204 can view the patient visit status (step 634), view archived (step 636), search patients (step 638) and view patent details/progress report (step 640).

After the physician 204 sets the plan of care (step 630), a particular type of provider is determined, i.e., what resource is needed, and a list of branches (step 642) are provided to the patient 202. The patient 202 then selects a branch (step 644) for a particular provider 206. This can be based on rating, availability, type, and location. The physician 204 refers the patient (step 646) and sends a referral (steps 648, 650) to the coordinator 502B.

After the coordinator account is created (step 616), the coordinator 502B can activate the account (step 652) and then create provider accounts (step 654). The coordinator 502B can also edit branch details/service area (step 656), create teams (step 658), and view patients (step 660). In viewing the patients (step 660), the coordinator 502B can add providers 662, upload progress reports (step 664), and search for patients/providers (step 666). Subsequent to the referral (step 650), the coordinator 502B can accept/reject referrals (step 670). Also, in editing (step 656), the coordinator 502B can create teams service areas (step 672) and add providers to the team (step 674). After the referrals (step 670), the coordinator 502B can view provider 206 availability (step 676) and assign the plan of care to a provider 206 (step 678).

Subsequent to creation of the provider account (step 654), the provider 206 can activate the account (step 680) and then view/edit profile (step 682) and view team/service area (step 684), view/update availability (step 686), view reports (step 688), and accept/reject referrals (step 690). Note, the view/update availability step 686 can be performed automatically through the mobile device 400. After accepting a referral (step 690), the patient 202 becomes one of the provider's 206 patients (step 692). The providers 206 can search patients (step 698), set visit status (step 700), and receive a visit rating (steps 702, 704) from the patient 202 after or during the visit.

### §7.0 Graphical User Interface

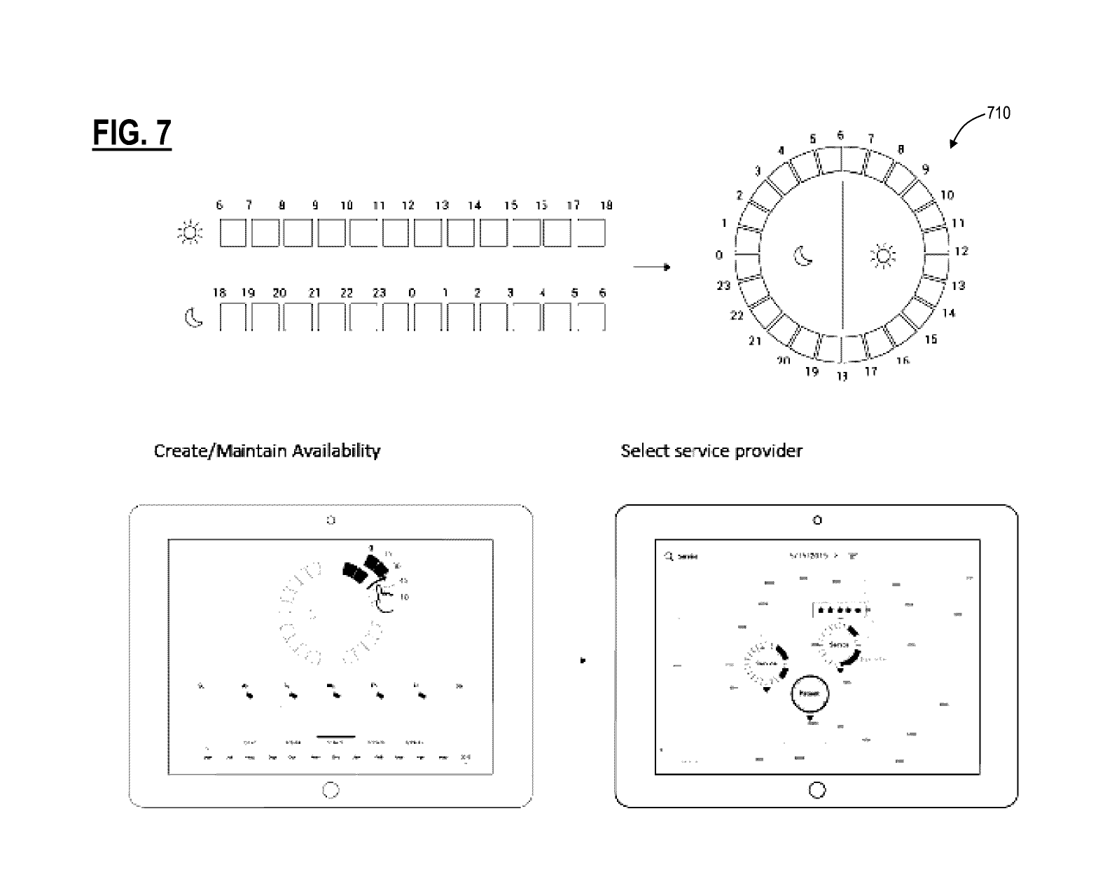

Referring to FIG. 7, in an exemplary embodiment, a Graphical User Interface (GUI) screen illustrates a convenient mechanism of availability management in the system 100. A dial 710 is used to display graphically availability for an entire day. The dial 710 is an efficient way to convey availability for an entire day in a small amount of space on the GUI screen. Further, the dial 710 can be overlaid on a map, allowing the physician 204 and/or the patient 202 to determine the best location/availability easily.

### §8.0 Exemplary Operation Through GUI Screens

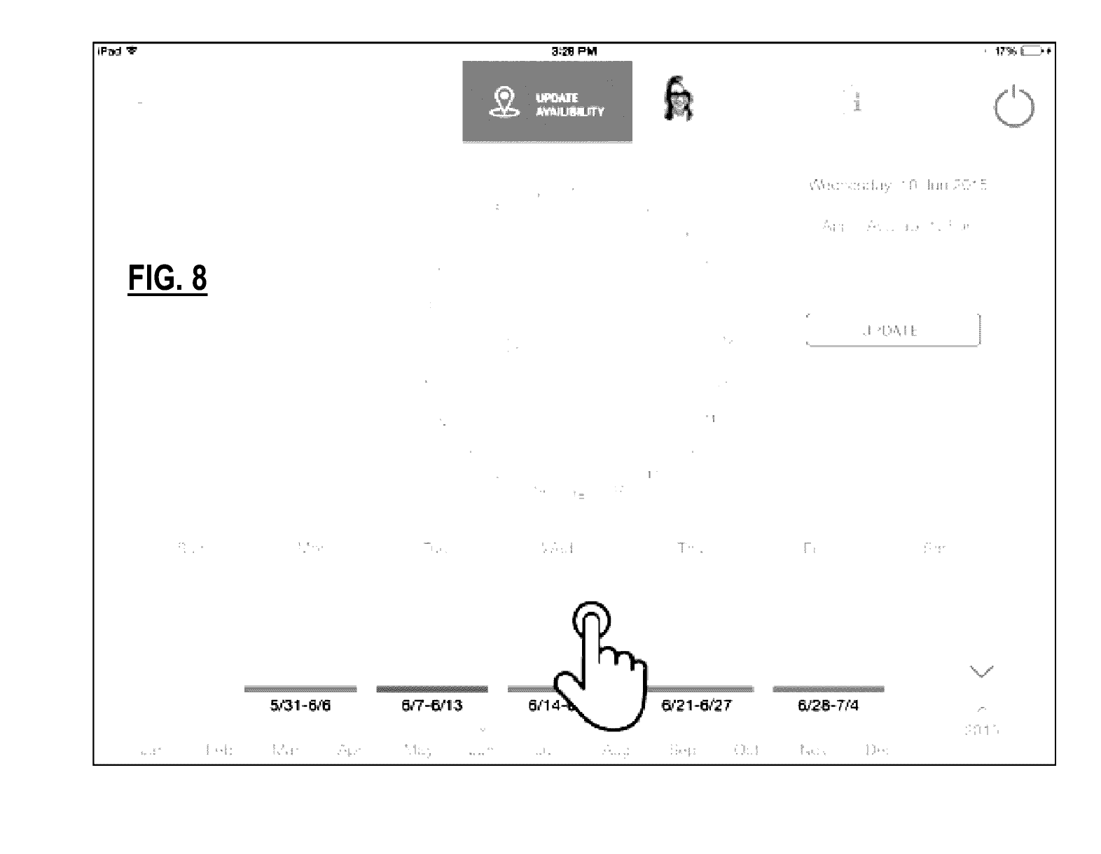

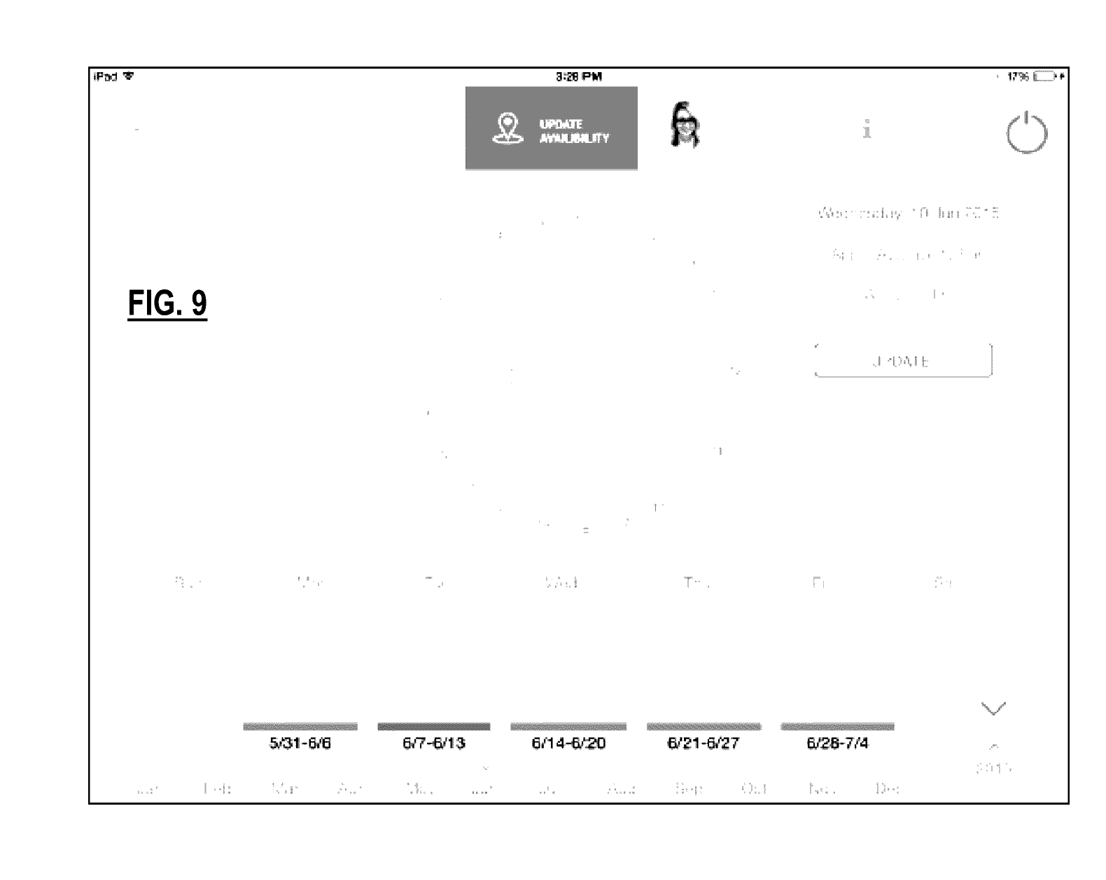

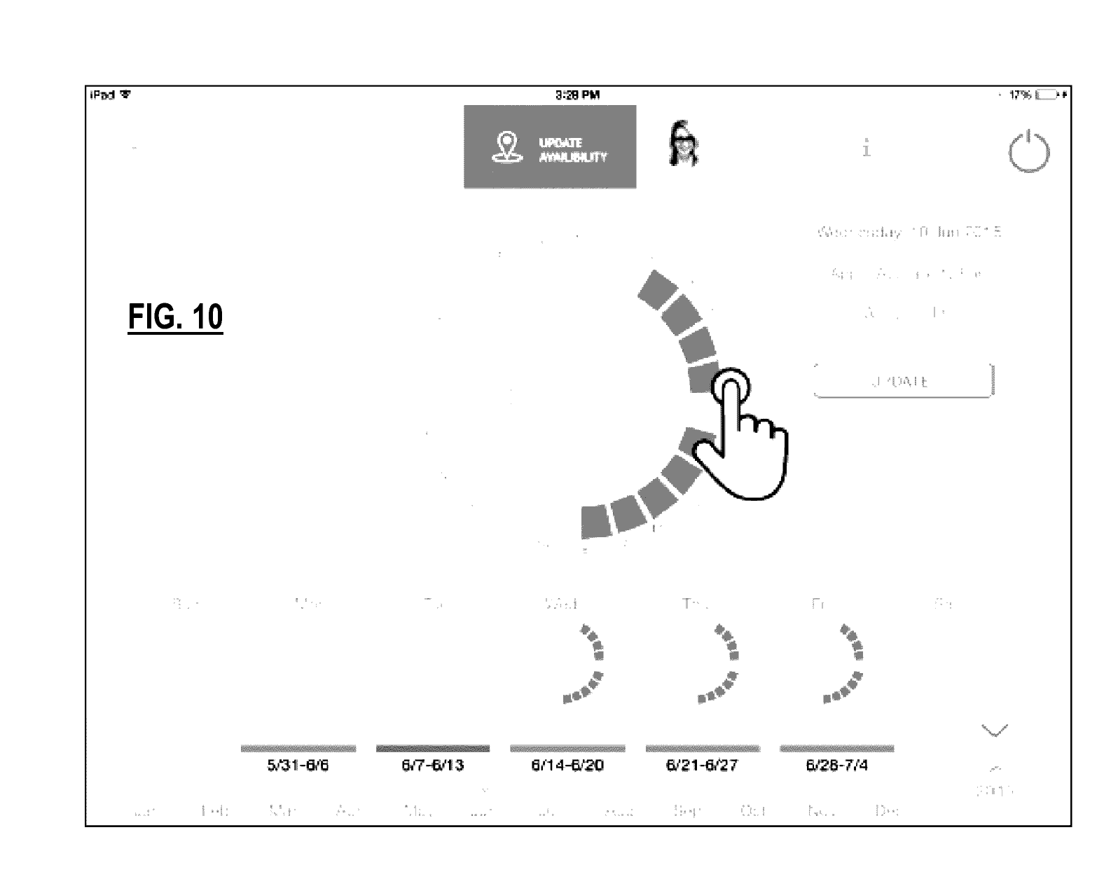

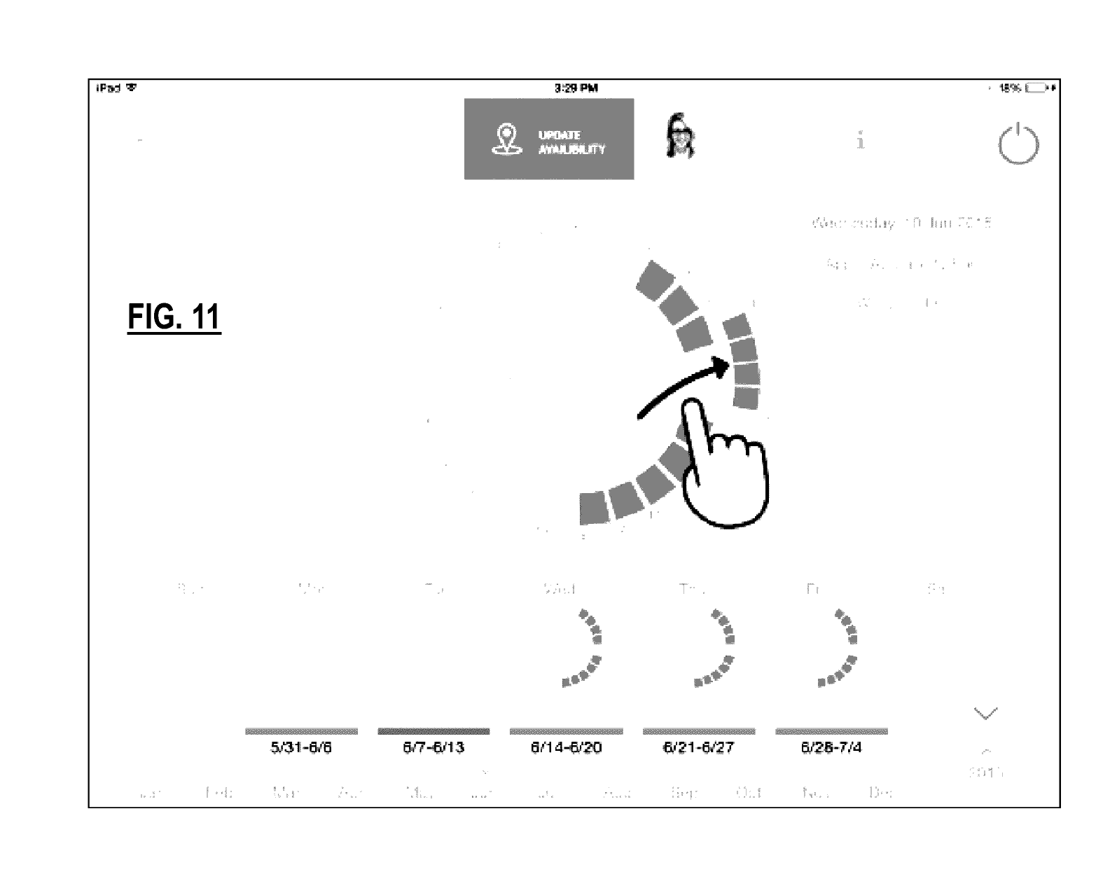

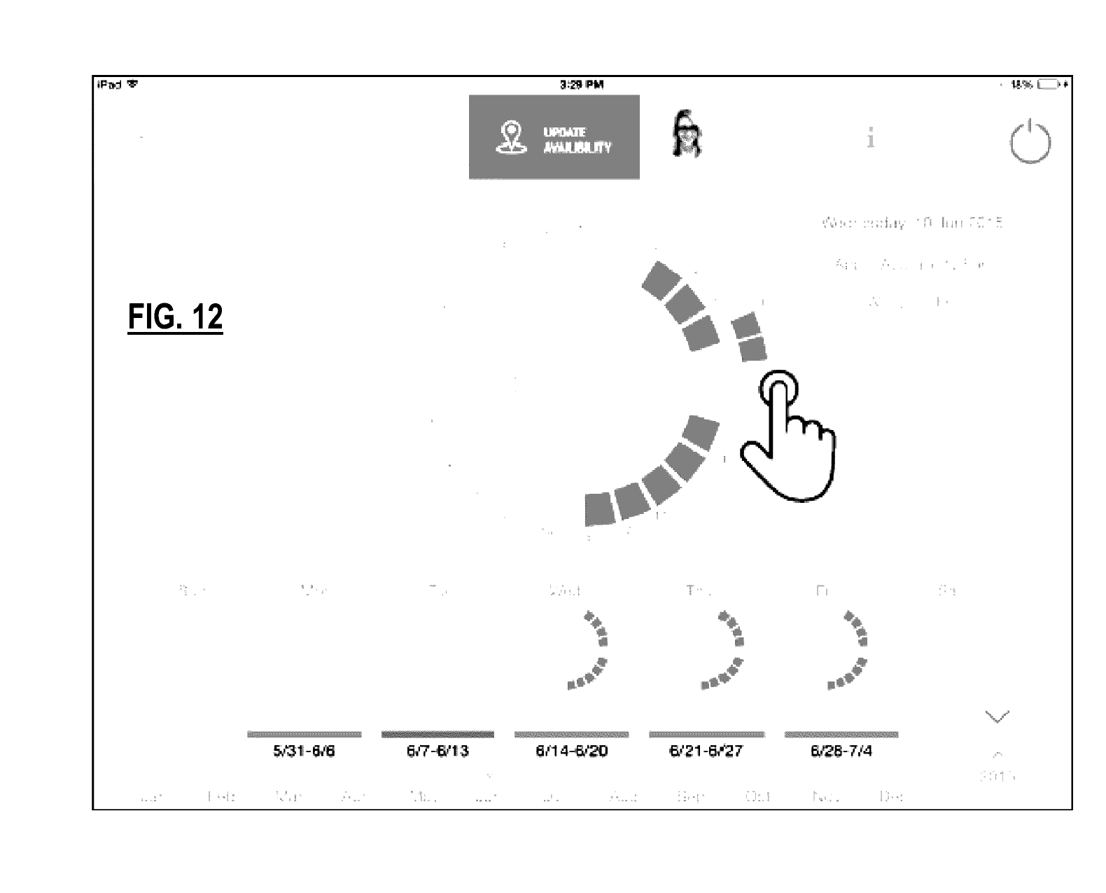

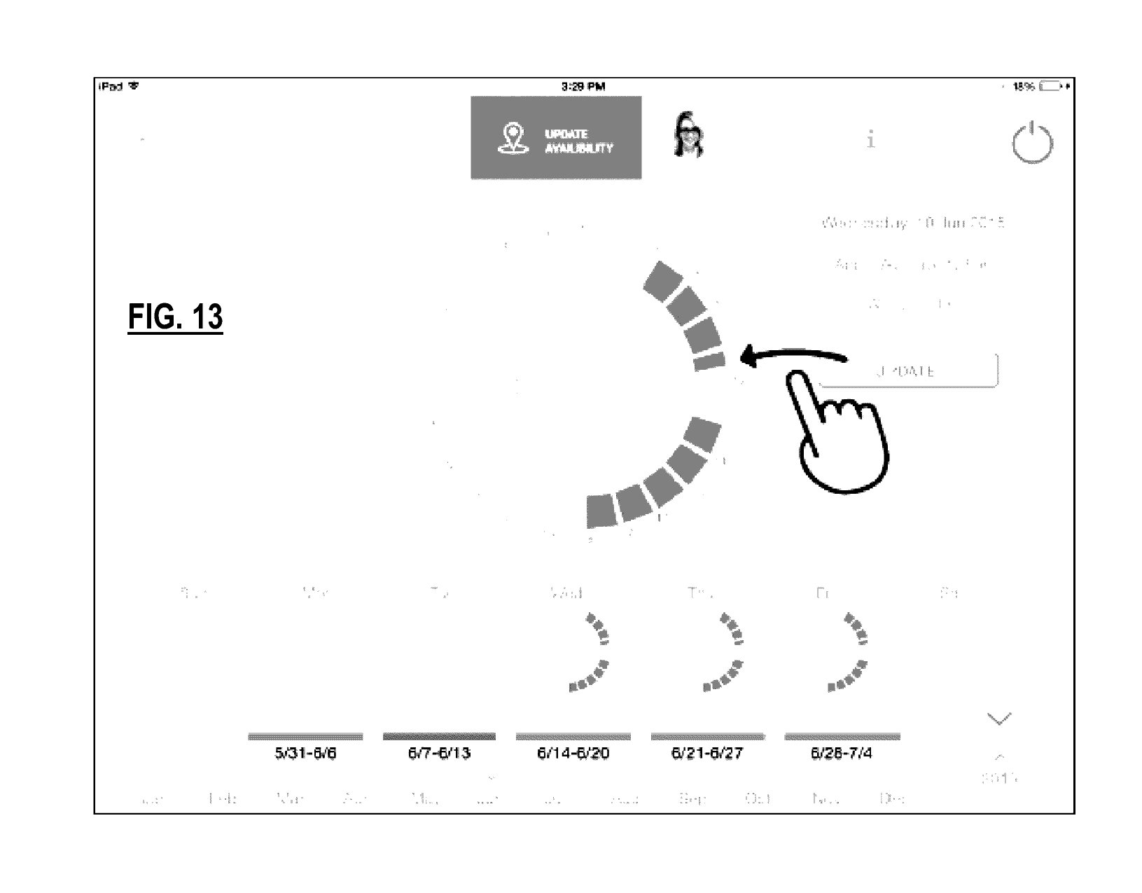

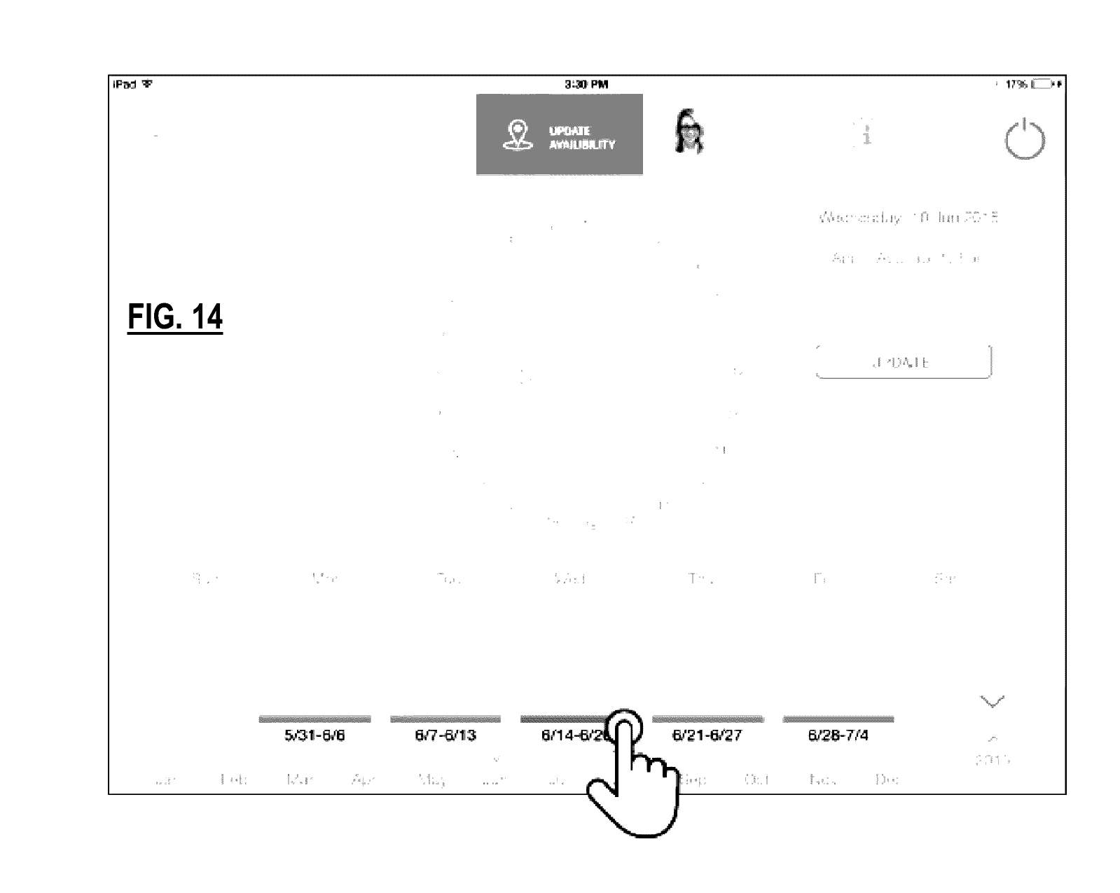

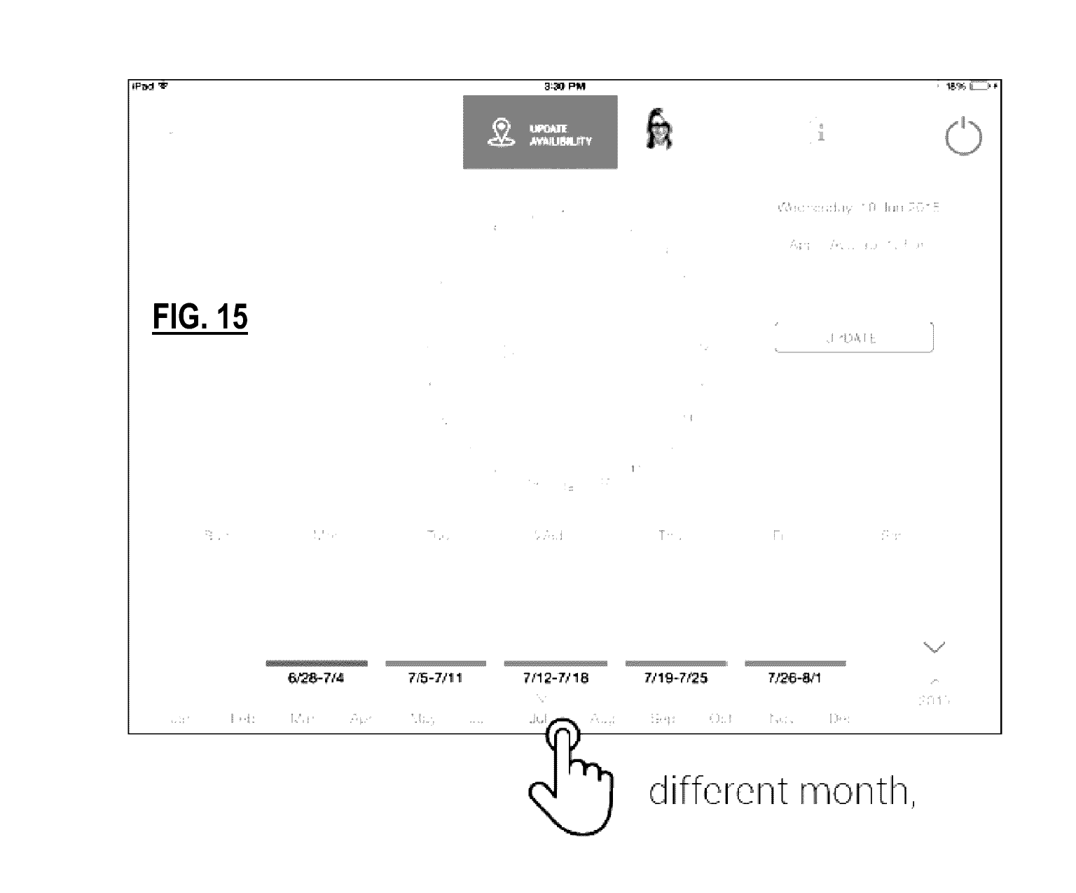

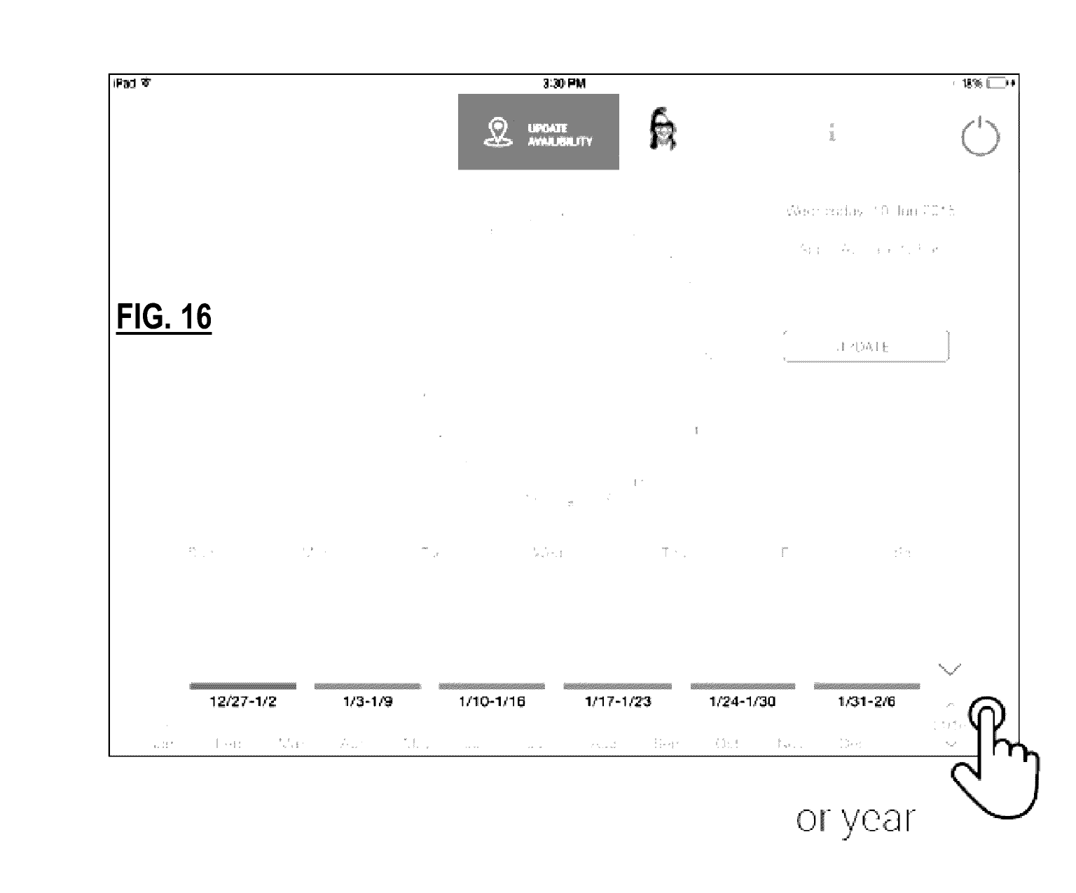

Referring to FIGS. 8-19, in various exemplary embodiments, GUI screens illustrate operations of the system 100, on a mobile device 400. FIG. 8 shows selecting days that a resource is available, and FIG. 9 shows the days selected. FIG. 10 shows the dial 710 and selecting slots to show or select available time. FIG. 11 shows selecting an hour slot on the dial 710 to shown additional granularity, e.g., in 15-minute detail. FIG. 12 shows selecting/deselecting 15-minute slots. FIG. 13 shows a swipe gesture to close the additional granularity on the dial 710. FIG. 14 shows navigating to a different week, to a different month (FIG. 15), or a different year (FIG. 16).

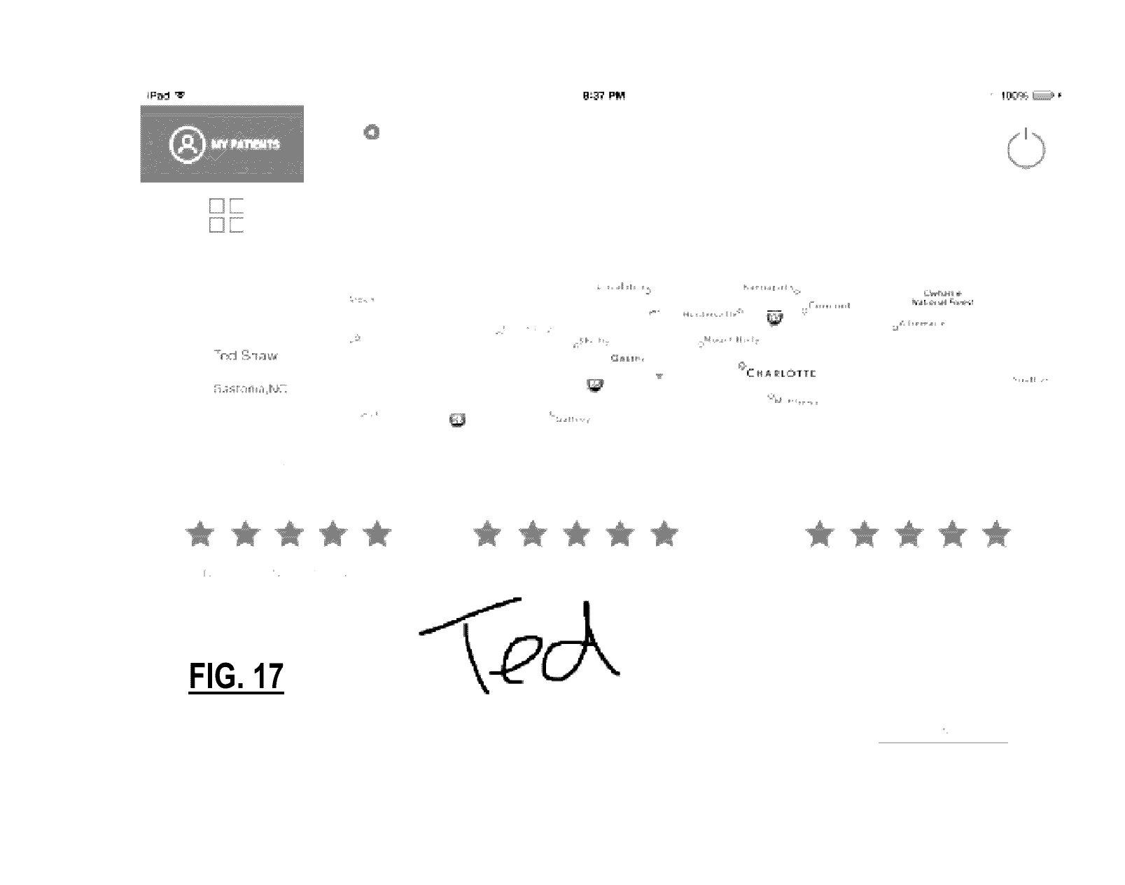

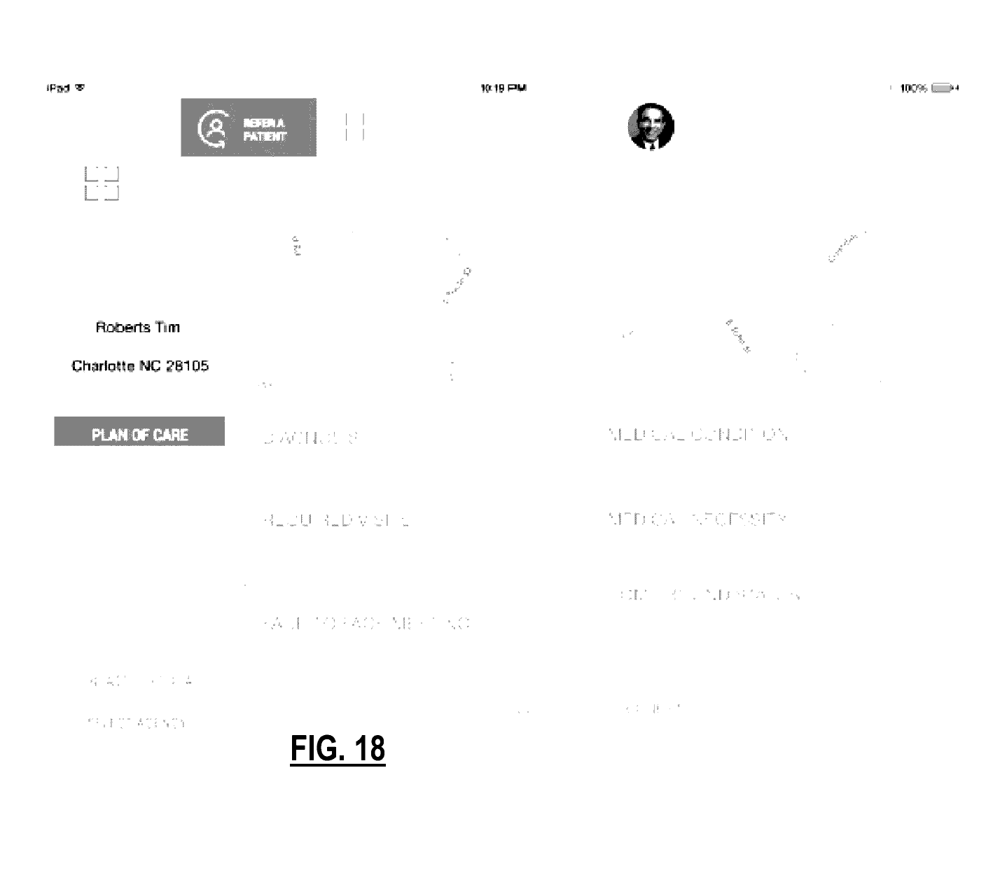

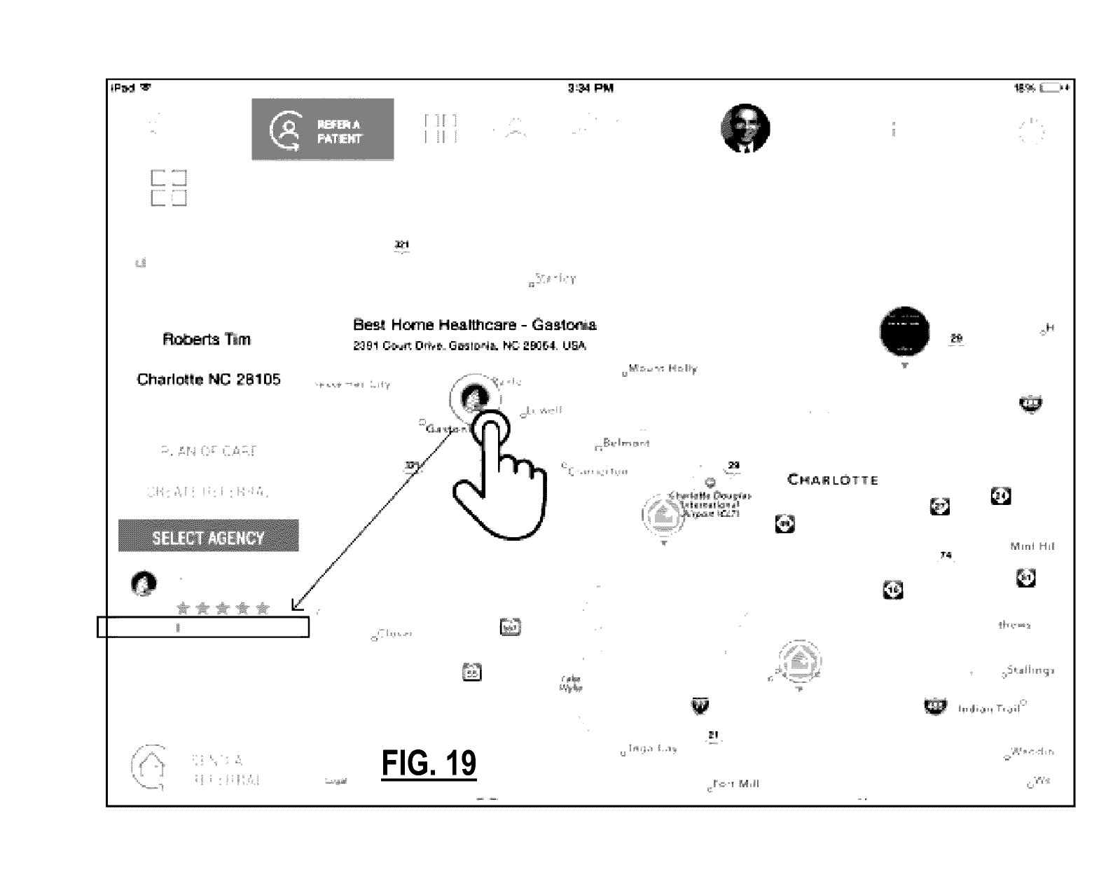

FIG. 17 is a GUI screen where the patient 202 can rate the visit as well as provide other input, feedback, a signature, etc. FIGS. 18 and 19 illustrate physician selection screens where the physician and/or patient is able to select a provider based on type of service, availability, location, and rating.

### §9.0 Healthcare Resource Availability and Allocation Method

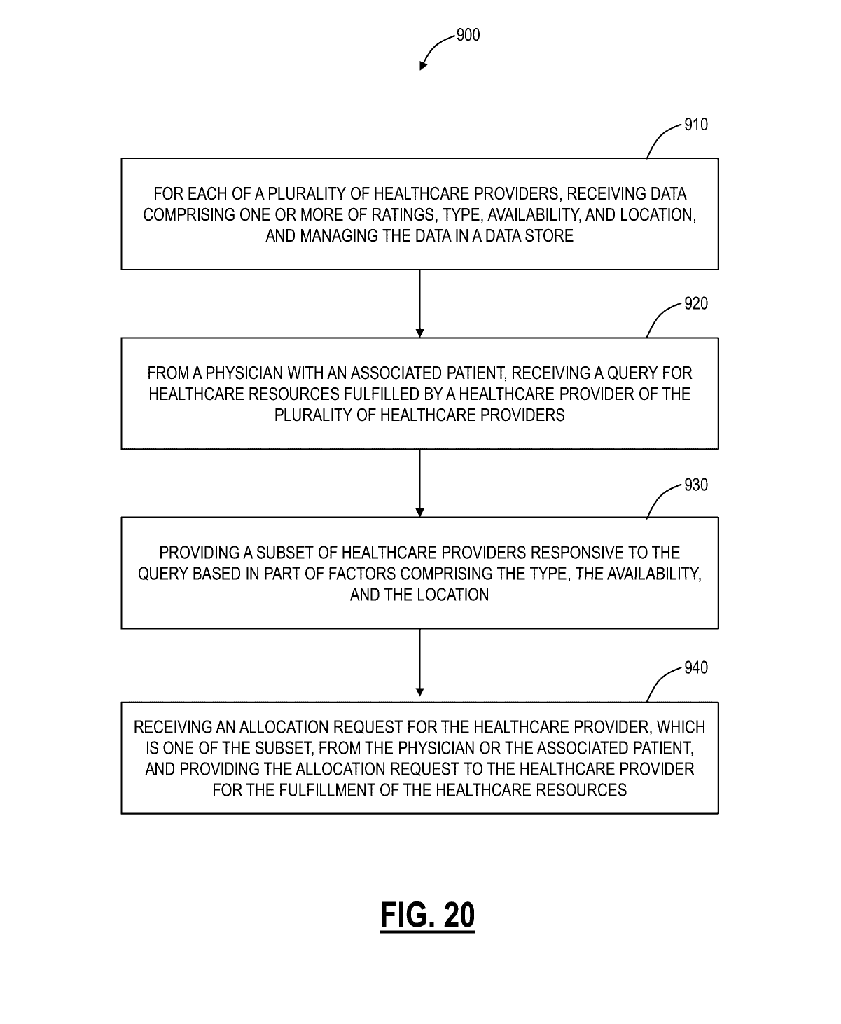

Referring to FIG. 20, in an exemplary embodiment, a flow chart illustrates a healthcare resource availability and allocation method 900. The resource availability and allocation method 900 includes, for each of a plurality of healthcare providers, receiving data comprising one or more of ratings, type, availability, and location, and managing the data in a data store (step 910); from a physician with an associated patient, receiving a query for healthcare resources fulfilled by a healthcare provider of the plurality of healthcare providers (step 920); providing a subset of healthcare providers responsive to the query based in part of factors comprising the type, the availability, and the location (step 930); and receiving an allocation request for the healthcare provider, which is one of the subset, from the physician or the associated patient, and providing the allocation request to the healthcare provider for the fulfillment of the healthcare resources (step 940).

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A healthcare resource availability and allocation method, comprising:
for each of a plurality of healthcare providers, receiving data comprising one or more of ratings, type, availability, and location, and managing the data in a data store;
from a physician with an associated patient, receiving a query for healthcare resources fulfilled by a healthcare provider of the plurality of healthcare providers;
providing a subset of healthcare providers responsive to the query based in part of factors comprising the type, the availability, the ratings, and the location; and
receiving an allocation request for the healthcare provider, which is one of the subset, from the physician or the associated patient, and providing the allocation request to the healthcare provider for the fulfillment of the healthcare resources.

2. The healthcare resource availability and allocation method of claim 1, wherein the providing is constrained based on the location, reported by a mobile device which provided the query or based on a fixed location which was pre-entered.

3. The healthcare resource availability and allocation method of claim 1, further comprising:
providing a Graphical User Interface (GUI) to a mobile device or to a Web browser, wherein the comprises a dial representing availability for a single day.

4. The healthcare resource availability and allocation method of claim 1, further comprising:
receiving updates subsequent to the allocation request, wherein the updates comprise one or more of a progress report from the healthcare provider and a rating from the patient subsequent to the fulfillment.

5. The healthcare resource availability and allocation method of claim 1, further comprising:
managing the healthcare resources based on the ratings, the type, the availability, and the location.

6. The healthcare resource availability and allocation method of claim 1, wherein the type comprises one or more of human resources, machine resources, and facility resources, and the type is determined as part of a plan of care determined by the physician.

7. The healthcare resource availability and allocation method of claim 1, wherein the healthcare resources comprise one or more of a compounding pharmacy, diagnostic imaging, home healthcare services, laboratory services, outpatient rehabilitation services, surgery centers, and urgent care centers.

8. A healthcare resource availability and allocation system, comprising:
a network interface and a processor communicatively coupled to one another; and
memory storing instructions that, when executed, cause the processor to
for each of a plurality of healthcare providers, receive data, via the network interface, comprising one or more of ratings, type, availability, the ratings, and location, and managing the data in a data store;
from a physician with an associated patient, receive, via the network interface, a query for healthcare resources fulfilled by a healthcare provider of the plurality of healthcare providers;
provide, via the network interface, a subset of healthcare providers responsive to the query based in part of factors comprising the type, the availability, and the location; and
receive, via the network interface, an allocation request for the healthcare provider, which is one of the subset, from the physician or the associated patient, and provide the allocation request to the healthcare provider for the fulfillment of the healthcare resources.

9. The healthcare resource availability and allocation system of claim 8, wherein the providing is constrained based on the location, reported by a mobile device which provided the query or based on a fixed location which was pre-entered.

10. The healthcare resource availability and allocation system of claim 8, wherein the memory storing instructions that, when executed, further cause the processor to
provide a Graphical User Interface (GUI) to a mobile device or to a Web browser, wherein the comprises a dial representing availability for a single day.

11. The healthcare resource availability and allocation system of claim 8, wherein the memory storing instructions that, when executed, further cause the processor to
receive updates subsequent to the allocation request, wherein the updates comprise one or more of a progress report from the healthcare provider and a rating from the patient subsequent to the fulfillment.

12. The healthcare resource availability and allocation system of claim 8, wherein the memory storing instructions that, when executed, further cause the processor to
manage the healthcare resources based on the ratings, the type, the availability, and the location.

13. The healthcare resource availability and allocation system of claim 8, wherein the type comprises one or more of human resources, machine resources, and facility resources, and the type is determined as part of a plan of care determined by the physician.

14. The healthcare resource availability and allocation system of claim 8, wherein the healthcare resources comprise one or more of a compounding pharmacy, diagnostic imaging, home healthcare services, laboratory services, outpatient rehabilitation services, surgery centers, and urgent care centers.

15. A mobile device, comprising:
a network interface, a location determination device, and a processor communicatively coupled to one another; and
memory storing instructions that, when executed, cause the processor to
provide data comprising one or more of ratings, type, availability, and location to a healthcare resource availability and allocation system;
present a Graphical User Interface (GUI) responsive to received data from the healthcare resource availability and allocation system;
perform a query for healthcare resources fulfilled by a healthcare provider of the plurality of healthcare providers;
provide a subset of healthcare providers responsive to the query based in part of factors comprising the type, the availability, the ratings, and the location; and
send an allocation request for the healthcare provider, which is one of the subset, from the physician or the associated patient.

16. The mobile device of claim 15, wherein the query is performed by communication of the location, as determined by the location determination device, to the healthcare resource availability and allocation system along with a specific request for the healthcare provider.

17. The mobile device of claim 15, wherein the memory storing instructions that, when executed, further cause the processor to
provide updates subsequent to the allocation request, wherein the updates comprise one or more of a progress report from the healthcare provider and a rating from the patient subsequent to the fulfillment.

18. The mobile device of claim 15, wherein the type comprises one or more of human resources, machine resources, and facility resources, and the type is determined as part of a plan of care determined by the physician.

19. The mobile device of claim 15, wherein the healthcare provider comprises one or more of a compounding pharmacy, diagnostic imaging, home healthcare services, laboratory services, outpatient rehabilitation services, surgery centers, and urgent care centers.
